(19) United States
(12) Patent Application Publication
(10) Pub. No.: US 2025/0297119 A1
(43) Pub. Date: Sep. 25, 2025

(54) Method Of Using Ink, Ink Set, Method Of Producing Ink Jet Ink Composition, And Ink Jet Ink Composition

(71) Applicant: SEIKO EPSON CORPORATION, Tokyo (JP)

(72) Inventors: Kenta UCHIDA, Matsumoto (JP); Hidehiko KOMATSU, Chino (JP)

(21) Appl. No.: 19/087,931

(22) Filed: Mar. 24, 2025

(30) Foreign Application Priority Data
Mar. 25, 2024 (JP) 2024-048240

(51) Int. Cl. C09D 11/38; C08K 5/17; C08K 5/21; C09D 7/80; C09D 11/328; C09D 11/40

(52) U.S. Cl. CPC C09D 11/38; C08K 5/175; C08K 5/21; C09D 7/80; C09D 11/328; C09D 11/40

(57) ABSTRACT

A method of using an ink according to an embodiment of the present disclosure includes: mixing an ink composition A, which contains a color material and a water-soluble substance being solid in an environment of 25° C. and 1 atmospheric pressure, in which a content of a substance being liquid in an environment of 25° C. and 1 atmospheric pressure is 20% by mass or less with respect to a total amount of the ink composition A, with an aqueous solution B, which contains water in an amount of 50% by mass or more with respect to a total amount of the aqueous solution B, when used in an ink jet printer, to obtain an ink jet ink composition C having a surface tension of 40 mN/m or less and a viscosity of 100 mPa·s or less after the mixing, and using the ink jet ink composition C by ejecting the ink jet ink composition C from the ink jet printer.

The present application is based on, and claims priority from JP Application Serial Number 2024-048240, filed Mar. 25, 2024, the disclosure of which is hereby incorporated by reference herein in its entirety.

### BACKGROUND

### 1. Technical Field

The present disclosure relates to a method of using an ink, an ink set, a method of producing an ink jet ink composition, and an ink jet ink composition.

### 2. Related Art

Ink jet recording methods can record high-definition images with a relatively simple device, and achieve rapid development in various fields. Among these, studies were conducted on the use of an ink composition (dry ink composition) from which at least a part of a liquid medium was removed.

For example, JP-A-2020-045469 discloses a method of producing an ink for ink jet recording including: step I: obtaining a water-based pigment dispersion (D) by mixing and dispersing water, a pigment, a resin (A′), and a neutralizing agent (b); step II: obtaining a pigment-containing resin composition having a content of a volatile substance of 1% by mass or less by subjecting the water-based pigment dispersion (D) obtained in the step I to a drying treatment; and step III: obtaining an ink for ink jet recording by mixing the pigment-containing resin composition obtained in the step II and a liquid compound.

However, in the method in the related art, an environmental load during transportation or a storage space pressure during ink storage, which is caused by the weight of the ink medium, could not be reduced. In addition, favorable resolubility/redispersibility and intermittent printing stability of an ink jet ink composition obtained by adding a liquid medium to a dry ink composition while obtaining favorable storage stability of the dry ink composition were not obtained.

### SUMMARY

According to an aspect of the present disclosure, there is provided a method of using an ink, the method including: mixing an ink composition A, which contains a color material and a water-soluble substance being solid in an environment of 25° C. and 1 atmospheric pressure, in which a content of a substance being liquid in an environment of 25° C. and 1 atmospheric pressure is 20% by mass or less with respect to a total amount of the ink composition A, with an aqueous solution B, which contains water in an amount of 50% by mass or more with respect to a total amount of the aqueous solution B, when used in an ink jet printer, to obtain an ink jet ink composition C having a surface tension of 40 mN/m or less and a viscosity of 100 mPa·s or less after the mixing, and using the ink jet ink composition C by ejecting the ink jet ink composition C from the ink jet printer.

According to another aspect of the present disclosure, there is provided an ink set including: an ink composition A, which contains a color material and a water-soluble substance being solid in an environment of 25° C. and 1 atmospheric pressure, in which a content of a substance being liquid in an environment of 25° C. and 1 atmospheric pressure is 20% by mass or less with respect to a total amount of the ink composition A, and an aqueous solution B, which contains water in an amount of 50% by mass or more with respect to a total amount of the aqueous solution B, in which the ink composition A and the aqueous solution B are used by being mixed such that a surface tension is 40 mN/m or less and a viscosity is 100 mPa·s or less.

According to still another aspect of the present disclosure, there is provided a method of producing an ink jet ink composition, the method including: mixing an ink composition A, which contains a color material and a water-soluble substance being solid in an environment of 25° C. and 1 atmospheric pressure, in which a content of a substance being liquid in an environment of 25° C. and 1 atmospheric pressure is 20% by mass or less with respect to a total amount of the ink composition A, with an aqueous solution B, which contains water in an amount of 50% by mass or more with respect to a total amount of the aqueous solution B, when used in an ink jet printer, in which the ink jet ink composition has a surface tension of 40 mN/m or less and a viscosity of 100 mPa·s or less.

According to still another aspect of the present disclosure, there is provided an ink jet ink composition including: an ink composition A, which contains a color material and a water-soluble substance being solid in an environment of 25° C. and 1 atmospheric pressure, in which a content of a substance being liquid in an environment of 25° C. and 1 atmospheric pressure is 20% by mass or less with respect to a total amount of the ink composition A, and an aqueous solution B, which contains water in an amount of 50% by mass or more with respect to a total amount of the aqueous solution B, in which the ink jet ink composition has a surface tension of 40 mN/m or less and a viscosity of 100 mPa·s or less.

### BRIEF DESCRIPTION OF THE DRAWINGS

FIG. 1 is a schematic view of describing a configuration of an ink jet head that may be used in the present embodiment.

FIG. 2 is a perspective view illustrating a serial type ink jet device according to the present embodiment.

FIG. 3 is Table 1 describing a composition example of an ink before drying.

FIG. 4 is Table 2 describing a composition example of the ink after drying.

FIG. 5 is Table 3 describing a composition example of an aqueous solution.

FIG. 6 is Table 4 describing a condition and an evaluation result of each example.

FIG. 7 is Table 5 describing a condition and an evaluation result of each example.

### DESCRIPTION OF EMBODIMENTS

Hereinafter, embodiments of the present disclosure will be described. The embodiments described below describe examples of the present disclosure. The present disclosure is not limited to the following embodiments, and includes various modifications implemented within a range not changing a gist of the present disclosure. It should be noted that not all of the configurations described below are essential configurations of the present disclosure.

In the present specification, a numerical range indicated by using “to” means a range including numerical values described before and after “to” as a lower limit value and an upper limit value.

### 1. Method of Using Ink

A method of using an ink according to an embodiment of the present disclosure is a method including: mixing an ink composition A, which contains a color material and a water-soluble substance being solid in an environment of 25° C. and 1 atmospheric pressure, in which a content of a substance being liquid in an environment of 25° C. and 1 atmospheric pressure is 20% by mass or less with respect to a total amount of the ink composition A, with an aqueous solution B, which contains water in an amount of 50% by mass or more with respect to a total amount of the aqueous solution B, when used in an ink jet printer, to obtain an ink jet ink composition C having a surface tension of 40 mN/m or less and a viscosity of 100 mPa·s or less after the mixing, and using the ink jet ink composition C by ejecting the ink jet ink composition C from the ink jet printer.

In the method in the related art, a mixed solution is not mixed immediately before use in the ink jet printer, and thus an environmental load due to transportation or a storage space could not be reduced. On the other hand, according to the method according to the present embodiment, the dry ink composition and the water-soluble solution are mixed immediately before use in the ink jet printer to be converted into an ink jet ink, and thus the environmental load due to transportation or the storage space can be minimized. For example, when a water-soluble solution containing water in an amount of 50% by mass or more is prepared when used in a printer, the environmental load due to transportation or the storage space can be suitably reduced.

In addition, the dry ink composition can obtain favorable resolubility/redispersibility by containing a color material and a water-soluble solid substance, and the water-soluble solution can obtain favorable intermittent printing stability by containing water in an amount of 50% by mass or more with respect to a total amount of the water-soluble solution. In addition, by setting a surface tension and a viscosity of the ink jet ink composition after the mixing to predetermined values, the ink jet ejection can be made stable.

Hereinafter, each step of the method according to the present embodiment will be described.

### 1.1 Ink Composition a Preparation Step

The method of using an ink according to the present embodiment includes an ink composition A preparation step of preparing an ink composition A. Hereinafter, each component contained in the ink composition A will be described.

The ink composition A contains a color material and a water-soluble substance being solid in an environment of 25° C. and 1 atmospheric pressure, and a content of a substance being liquid in an environment of 25° C. and 1 atmospheric pressure is 20% by mass or less with respect to a total amount of the ink composition A. As a result, favorable resolubility/redispersibility and storage stability can be obtained.

### 1.1.1 Color Material

An ink composition A contains a color material. Examples of the color material include a dye and a pigment.

### Dye

Examples of the dye include an acid dye, a direct dye, a reactive dye, a basic dye, and a disperse dye.

Yellow dye is not particularly limited, and examples thereof include C.I. Acid Yellow 1, 3, 11, 17, 19, 23, 25, 29, 36, 38, 40, 42, 44, 49, 59, 61, 70, 72, 75, 76, 78, 79, 98, 99, 110, 111, 127, 131, 135, 142, 162, 164, 165, C.I. Direct Yellow 1, 8, 11, 12, 24, 26, 27, 33, 39, 44, 50, 58, 85, 86, 87, 88, 89, 98, 110, 132, 142, 144, 162, 165, C.I. Reactive Yellow 1, 2, 3, 4, 6, 7, 11, 12, 13, 14, 15, 16, 17, 18, 22, 23, 24, 25, 26, 27, 37, 42, C.I. Food Yellow 3, 4, C.I. Solvent Yellow 15, 19, 21, 30, and 109.

Magenta dye is not particularly limited, and examples thereof include C.I. Acid Red 1, 6, 8, 9, 13, 14, 18, 26, 27, 32, 35, 37, 42, 51, 52, 57, 75, 77, 80, 82, 85, 87, 88, 89, 92, 94, 97, 106, 111, 114, 115, 117, 118, 119, 129, 130, 131, 133, 134, 138, 143, 145, 154, 155, 158, 168, 180, 183, 184, 186, 194, 198, 209, 211, 215, 219, 249, 252, 254, 262, 265, 274, 282, 289, 303, 317, 320, 321, 322, C.I. Direct Red 1, 2, 4, 9, 11, 13, 17, 20, 23, 24, 28, 31, 33, 37, 39, 44, 46, 62, 63, 75, 79, 80, 81, 83, 84, 89, 95, 99, 113, 197, 201, 218, 220, 224, 225, 226, 227, 228, 229, 230, 231, C.I. Reactive Red 1, 2, 3, 4, 5, 6, 7, 8, 11, 12, 13, 15, 16, 17, 19, 20, 21, 22, 23, 24, 28, 29, 31, 32, 33, 34, 35, 36, 37, 38, 39, 40, 41, 42, 43, 45, 46, 49, 50, 58, 59, 63, 64, 245, C.I. Solubilized Red 1, C.I. Food Red 7, 9, and 14.

Examples of cyan dye include C.I. Acid Blue 1, 7, 9, 15, 22, 23, 25, 27, 29, 40, 41, 43, 45, 54, 59, 60, 62, 72, 74, 78, 80, 82, 83, 90, 92, 93, 100, 102, 103, 104, 112, 113, 117, 120, 126, 127, 129, 130, 131, 138, 140, 142, 143, 151, 154, 158, 161, 166, 167, 168, 170, 171, 182, 183, 184, 187, 192, 199, 203, 204, 205, 229, 234, 236, 249, C.I. Direct Blue 1, 2, 6, 15, 22, 25, 41, 71, 76, 77, 78, 80, 86, 87, 90, 98, 106, 108, 120, 123, 158, 160, 163, 165, 168, 192, 193, 194, 195, 196, 199, 200, 201, 202, 203, 207, 225, 226, 236, 237, 246, 248, 249, C.I. Reactive Blue 1, 2, 3, 4, 5, 7, 8, 9, 13, 14, 15, 15:1, 17, 18, 19, 20, 21, 25, 26, 27, 28, 29, 31, 32, 33, 34, 37, 38, 39, 40, 41, 43, 44, 46, C.I. Solubilized Vat Blue 1, 5, 41, C.I. Vat Blue 4, 29, 60, C. I. Food Blue 1, 2, C.I. Basic Blue 9, 25, 28, 29, and 44.

Examples of orange dye include Acid Orange 3, 7, 8, 10, 19, 22, 24, 33, 45, 51, 51S, 56, 67, 74, 80, 86, 87, 88, 89, 94, 95, 107, 108, 116, 122, 127, 140, 142, 144, 149, 152, 156, 162, 166, 168, Direct Orange 1, 6, 8, 10, 26, 27, 34, 39, 40, 46, 49, 102, 105, 107, 118, Reactive Orange 1, 2, 4, 5, 7, 11, 12, 13, 15, 16, 20, 30, 35, 56, 64, 67, 69, 70, 72, 74, 82, 84, 86, 87, 91, 92, 93, 95, and 107.

Examples of black dye include Acid Black 1, 2, 7, 24, 26, 29, 31, 44, 48, 50, 51, 52, 52:1, 58, 60, 62, 63, 64, 67, 72, 76, 77, 94, 107, 108, 109, 110, 112, 115, 118, 119, 121, 122, 131, 132, 139, 140, 155, 156, 157, 158, 159, 172, 191, 194, 207, 234, Direct Black 9, 17, 19, 22, 32, 51, 56, 62, 69, 77, 80, 91, 94, 97, 108, 112, 113, 114, 117, 118, 121, 122, 125, 132, 146, 154, 166, 168, 173, 195, 199, Reactive Black 1, 3, 4, 5, 7, 8, 11, 12, 14, 17, 21, 23, 26, 31, 32, 34, and 39.

The above-mentioned dye may be used alone or in combination of two or more thereof.

### Pigment

As the pigment, for example, an inorganic pigment including carbon black and titanium white, an organic pigment, and the like can be used.

As the inorganic pigment, carbon blacks such as C.I. Pigment Black 6 (lamp black, vegetable black), C.I. Pigment Black 7 (furnace black, channel black, thermal black, acetylene black), C.I. Pigment Black 8 (charcoal black), and C.I. Pigment Black 10 (graphite), iron oxide, titanium oxide, zinc oxide, and silica can be used.

Examples of the carbon black include No. 2300, 900, MCF88, No. 20B, No. 33, No. 40, No. 45, No. 52, MA7, MA8, MA100, No2200B, and the like, manufactured by Mitsubishi Chemical Corporation. Examples include color black FW1, FW2, FW2V, FW18, FW200, S150, S160, S170, Pretex 35, U, V, 140U, special black 6, 5, 4A, 4, 250, and the like, manufactured by Degussa Corporation. Examples include Conductex SC, Raven 1255, 5750, 5250, 5000, 3500, 1255, 700, and the like, manufactured by Columbia Carbon Company. Examples include Regal 400R, 330R, and 660R, Mogul L, Monarch 700, 800, 880, 900, 1000, 1100, 1300, and 1400, Elftex 12, and the like, manufactured by Cabot Corporation.

Examples of the organic pigment include a quinacridone-based pigment, a quinacridone quinone-based pigment, a dioxazine-based pigment, a phthalocyanine-based pigment, an anthrapyrimidine-based pigment, an anthanthrone-based pigment, an indanthrone-based pigment, a flavanthrone-based pigment, a perylene-based pigment, a diketopyrrolopyrrole-based pigment, a perinone-based pigment, a quinophthalone-based pigment, an anthraquinone-based pigment, a thioindigo-based pigment, a benzoimidazolone-based pigment, an isoindolinone-based pigment, an azomethine-based pigment, an azo-based pigment, and the like.

Specific examples of the organic pigment used in the ink composition A include the following ones.

Examples of the cyan pigment include C.I. Pigment Blue 1, 2, 3, 15:3, 15:4, 15:34, 16, 22, 60, and the like; C.I. Vat Blue 4, 60; and the like, and are preferably a mixture of one or two or more selected from the group consisting of C.I. Pigment Blue 15:3, 15:4, and 60.

Examples of the magenta pigment include C.I. Pigment Red 5, 7, 12, 48(Ca), 48(Mn), 57(Ca), 57:1, 112, 122, 123, 168, 184, 202, C.I. Pigment Violet 19, and the like, and are preferably a mixture of one or two or more selected from the group consisting of C.I. Pigment Red 122, 202, and 209, and C.I. Pigment Violet 19. A solid solution of the pigment is also favorable.

Examples of the yellow pigment include C.I. Pigment Yellow 1, 2, 3, 12, 13, 14C, 16, 17, 73, 74, 75, 83, 93, 95, 97, 98, 119, 110, 114, 128, 129, 138, 150, 151, 154, 155, 180, 185, and the like, and preferably include a mixture of one or two or more selected from the group consisting of C.I. Pigment Yellow 74, 109, 110, 128, 138, 155, and 180.

Examples of the orange pigment include C.I. Pigment Orange 36 or 43 or a mixture thereof. Examples of the green pigment include C.I. Pigment Green 7 or 36 or a mixture thereof.

In addition, a bright pigment may be used, the pigment is not particularly limited as long as the pigment is able to exhibit brightness when adhered to a medium, and examples thereof include metal particles of one or two or more alloys (also referred to as metal pigment) selected from the group consisting of aluminum, silver, gold, platinum, nickel, chromium, tin, zinc, indium, titanium, and copper, a pearl pigment having pearl gloss, and the like. Representative examples of the pearl pigment include a pigment having pearl gloss or interference gloss such as titanium dioxide-coated mica, fish scale foil, and bismuth oxychloride. In addition, the bright pigment may be subjected to a surface treatment for suppressing a reaction with water.

In addition, a white pigment may be used, and examples of the white pigment include metal compounds such as metal oxide, barium sulfate, and calcium carbonate. Examples of the metal oxide include titanium dioxide, zinc oxide, silica, alumina, magnesium oxide, and the like. In addition, particles having a hollow structure may be used for the white pigment.

The above-mentioned pigments may be used alone or in combination of two or more thereof. The pigment is preferably an organic pigment from the viewpoint of storage stability such as light resistance, weather resistance, and gas resistance.

For the volume average particle diameter (D50) of the pigment, a volume average particle diameter (D50) when measured by a dynamic light scattering method is 20 nm or more and 300 nm or less, the volume average particle diameter (D50) is more preferably 30 nm or more and 200 nm or less, and the volume average particle diameter (D50) is further more preferably 40 nm or more and 100 nm or less.

The measurement of the volume average particle diameter may be performed by using, for example, a Nanotrac series particle diameter distribution measurement device manufactured by MicrotracBEL Corp. In addition, examples of a method of adjusting the volume average particle diameter include a method of adjusting a volume average particle diameter by adjusting a degree of pulverization of a pigment before dispersion, a method of adjusting a volume average particle diameter by adjusting stirring conditions (for example, stirring speed, stirring temperature, and the like) during dispersion, a method of adjusting a volume average particle diameter by filtration using a filter after dispersion, and the like.

In order to enhance the dispersibility of the pigment in the ink jet ink composition, it is preferable to perform a surface treatment on the pigment or to blend a dispersant or the like.

The surface treatment of the pigment is preferably a treatment to directly or indirectly bond a carbonyl group, a carboxyl group, an aldehyde group, a hydroxyl group, a sulfone group, an ammonium group, a functional group formed of salts thereof, or the like to the surface of the pigment by physical or chemical treatment. In particular, the surface treatment is more preferably a surface treatment to modify surfaces of pigment particles such that the surface of the pigment is oxidized or sulfonated with, for example, ozone, hypochlorous acid, fuming sulfuric acid, and the like.

When a dispersant is blended in the ink composition A, a dispersant having a hydrophobic portion (hydrophobic group) and a hydrophilic portion (hydrophilic group) in the molecular structure are preferably used. Such a dispersant has an action in which the hydrophobic portion is adsorbed on the particle surface of the pigment and the hydrophilic portion is oriented to the aqueous medium side of the ink jet ink composition. As a result of this action, there is a tendency that the pigment can be stably contained in the ink jet ink composition as a dispersant.

Such a dispersant is not particularly limited, and examples thereof include styrene-acrylic resin such as an acrylic resin, a styrene-(meth)acrylic acid copolymer, and a styrene-(meth)acrylic acid-(meth)acrylate copolymer, a styrene-maleic acid-based resin, salts thereof, formalin condensates of aromatic sulfonate, and the like, and one or more selected from these groups can be adopted. A commercially available product may be used as the dispersant.

When the pigment is dispersed by a dispersant, a ratio of the pigment to the dispersant is preferably 10:1 to 1:10, and more preferably 4:1 to 1:3.

In addition, a method of coating particles of the pigment with a resin or the like to impart dispersibility may be used. As a method of coating the pigment particles, an acid analysis method, a phase inversion emulsification method, a mini-emulsion polymerization method, and the like can be adopted.

The color material contained in the ink composition A is preferably a water-soluble color material. When the color material is a water-soluble color material, the resolubility/redispersibility when the color material is formulated into an ink jet ink composition tends to be more excellent.

The term “water-soluble” in the color material means that at least a part of the color material is dissolved in water at 20° C. Preferably, a degree of solubility in water at 20° C. is more than 1 g/100 g of water, more preferably, the degree of solubility in water at 20° C. is more than 3 g/100 g of water, and further more preferably, the degree of solubility in water at 20° C. is more than 5 g/100 g of water.

Examples of the water-soluble color material include acid dye, direct dye, reactive dye, basic dye, and the like.

The color material contained in the ink composition A is preferably a dye. When the color material is a dye, the resolubility/redispersibility when the color material is formulated into an ink jet ink composition tends to be more excellent.

The color material contained in the ink composition A is preferably a reactive dye. In the presence of water, the hydrolysis of the reactive dye proceeds, and the reactive group of the reactive dye is inactivated. On the other hand, the method according to the present embodiment tends to be able to reduce the inactivation of the reactive group and obtain favorable dyeability because the ink composition A is mixed with the liquid medium immediately before the use in the ink jet printer.

A content of the color material is preferably 35% by mass or less, more preferably 30% by mass or less, and further more preferably 25% by mass or less with respect to a total amount of the ink composition A. When the content of the color material is within the above range, the resolubility/redispersibility when the color material is formulated into an ink jet ink composition tends to be more excellent.

A lower limit of the content of the color material is not particularly limited, and is preferably 5% by mass or more, more preferably 10% by mass or more, further more preferably 15% by mass or more, and particularly preferably 20% by mass or more, with respect to the total amount of the ink composition A.

### 1.1.2 Water-Soluble Solid Substance

The ink composition A contains a water-soluble substance being solid (hereinafter, also referred to as “water-soluble solid substance”) in an environment of 25° C. and 1 atmospheric pressure. The “water-soluble” in the water-soluble solid substance is the same as the “water-soluble”in the above-described color material.

The water-soluble solid substance may be any substance as long as the substance is water-soluble and solid in an environment of 25° C. and 1 atmospheric pressure, but is, for example, preferably one or more selected from a moisturizing agent, a surfactant, and a solubilizing agent. In this case, the resolubility/redispersibility and intermittent printing stability tend to be more favorable.

### 1.1.2.1 Moisturizing Agent

The ink composition A preferably contains a moisturizing agent. The moisturizing agent has a function of suppressing the volatilization of moisture, and tends to obtain favorable intermittent printing stability when the ink composition A is formulated into the ink jet ink composition.

Examples of the moisturizing agent include ureas. Examples of ureas include urea, ethylene urea, tetramethyl urea, thiourea, and the like, and betaines (trimethylglycine, triethylglycine, tripropylglycine, triisopropylglycine, N,N,N-trimethylalanine, N,N,N-triethylalanine, N,N,N-triisopropylalanine, N,N,N-trimethylmethylalanine, carnitine, acetyl carnitine, and the like).

A content of the moisturizing agent is preferably 10% to 70% by mass, more preferably 30% to 60% by mass, further more preferably 40% to 60% by mass, and particularly preferably 50% to 60% by mass, with respect to the total amount of the ink composition A.

### 1.1.2.2 Surfactant

The ink composition A preferably contains a surfactant. By containing the surfactant, the intermittent printing stability when the ink composition A is formulated into an ink jet ink composition tends to be favorable.

Among the surfactants, for example, acetylene glycol-based surfactant, silicone-based surfactant, and fluorine-based surfactant can be preferably used.

The acetylene glycol-based surfactant is not particularly limited, and examples thereof include SURFYNOL 104E, 104H, 104A, 104PA, 104S, and DF110D (all product names, manufactured by Air Products & Chemicals, Inc.), OLFINE E1004, E1010, E1020, PD-001, PD-002W, PD-003, PD-004, EXP. 4001, EXP. 4036, and EXP. 4051 (all product names, manufactured by Nissin Chemical Industry Co., LTD.), and ACETYLENOL E00 and E200 (all product names, manufactured by Kawaken Fine Chemicals Co., Ltd.).

The silicone-based surfactant is not particularly limited, and examples thereof preferably include a polysiloxane-based compound. The polysiloxane-based compound is not particularly limited, and examples thereof include polyether-modified organosiloxane. Examples of commercially available products of the polyether-modified organosiloxane include KF-6004 (all product names, manufactured by Shin-Etsu Chemical Co., Ltd.) and the like.

As the fluorine-based surfactant, a fluorine-modified polymer is preferably used, and specific examples thereof include SURFLON S-242 (product name, manufactured by AGC Seimi Chemical Co., Ltd.), Futagent 245F (manufactured by Neos Corporation), and the like.

A content of the surfactant is preferably 0.1% to 10% by mass, more preferably 0.5% to 8% by mass, further more preferably 0.5% to 5% by mass, and particularly preferably 1% to 3% by mass, with respect to the total amount of the ink composition A.

### 1.1.2.3 Solubilizing Agent

The ink composition A preferably contains a solubilizing agent. The term “solubilizing agent” means an agent that promotes dissolution of one or more components of the ink composition A in water. By containing the solubilizing agent, the intermittent printing stability when the ink composition A is formulated into an ink jet ink composition tends to be favorable.

The solubilizing agent is not particularly limited, but is preferably amides. Among the amides, cyclic amides are preferable, and lactams such as ε-caprolactam are particularly preferable.

A content of the solubilizing agent is preferably 10% to 50% by mass, more preferably 15% to 40% by mass, further more preferably 15% to 30% by mass, and particularly preferably 15% to 25% by mass, with respect to the total amount of the ink composition A.

Among these, the water-soluble substance being solid in an environment of 25° C. and 1 atmospheric pressure is preferably one or more selected from trimethylglycine, urea, and ε-caprolactam, and more preferably contains trimethylglycine, urea, and ε-caprolactam. In this case, the intermittent printing stability when the ink composition A is formulated into an ink jet ink composition tends to be favorable.

A content of the water-soluble solid substance is preferably 10% to 50% by mass, more preferably 15% to 40% by mass, further more preferably 15% to 30% by mass, and particularly preferably 15% to 25% by mass, with respect to the total amount of the ink composition A.

### 1.1.3 Liquid Substance

In the ink composition A, a content of a substance being liquid (hereinafter, also referred to as “liquid substance”) in an environment of 25° C. and 1 atmospheric pressure is 20% by mass or less with respect to the total amount of the ink composition A. When the content of the liquid substance is 20% by mass or less with respect to the total amount of the ink composition A, the storage stability of the ink composition A can be made favorable. In addition, since the hydrolysis reaction of the color material can be reduced, favorable color development properties can be obtained. The content of the liquid substance is 20% by mass or less, preferably 15% by mass or less, more preferably 10% by mass or less, further more preferably 5% by mass or less, particularly preferably 3% by mass or less, more particularly preferably 18 by mass or less, and still more particularly preferably 0.5% by mass or less, with respect to the total amount of the ink composition A, and the content of the liquid substance is even more preferably not contained (0% by mass).

Examples of the liquid substance include water and an organic solvent. Details of water and organic solvent will be described later.

### 1.1.4 Water-Insoluble Solid Substance

In the ink composition A, a content of a water-insoluble substance being solid (hereinafter, also referred to as “water-insoluble solid substance”) in an environment of 25° C. and 1 atmospheric pressure other than the color material is preferably 5% by mass or less, more preferably 3% by mass or less, further more preferably 18 by mass or less, and particularly preferably 0.1% by mass or less, with respect to the total amount of the ink composition A, and the water-insoluble solid substance is particularly preferably not contained (0% by mass). When the water-insoluble solid substance is within the above range, the intermittent printing stability tends to be favorable.

The term “water-insoluble” means that the substance is not “water-soluble”. The term “water-insoluble” means, for example, that the degree of solubility in water at 20° C. is 0 g/100 g of water.

The water-insoluble solid substance is not particularly limited, and examples thereof include a resin, inorganic particles, and the like.

Examples of the resin include urethane-based resin, acrylic resin, fluorene-based resin, polyolefin-based resin, rosin-modified resin, terpene-based resin, polyester-based resin, polyamide-based resin, epoxy-based resin, vinyl chloride-based resin, ethylene vinyl acetate-based resin, vinyl acetate resin, butadiene resin, styrene resin, crosslinked acrylic resin, crosslinked styrene resin, benzoguanamine resin, phenol resin, silicone resin, epoxy resin, paraffin resin, fluororesin, and the like. As the properties of the resin, for example, a wax or a powder may be used, and a powder is preferable.

A urethane-based resin is a general term for a resin having a urethane bond. For the urethane-based resin, a polyether-type urethane resin including an ether bond in the main chain, a polyester-type urethane resin including an ester bond in the main chain, and a polycarbonate-type urethane resin including a carbonate bond in the main chain, in addition to a urethane bond, and the like may be used.

An acrylic resin is a general term for polymers obtained by polymerizing at least an acrylic monomer such as (meth)acrylic acid and (meth)acrylic acid ester as one component, and examples thereof include a resin obtained from an acrylic monomer, a copolymer of an acrylic monomer and a monomer other than acrylic monomer, and the like. Examples thereof include an acrylic-vinyl-based resin which is a copolymer of an acrylic monomer and a vinyl-based monomer and the like. In addition, examples thereof include a copolymer with a vinyl-based monomer such as styrene. As the acrylic monomer, acrylamide, acrylonitrile, and the like can also be used.

The styrene acrylic resin is a copolymer obtained from a styrene monomer and an acrylic monomer, and examples thereof include a styrene-acrylic acid copolymer, a styrene-methacrylic acid copolymer, a styrene-methacrylic acid-acrylic acid ester copolymer, a styrene-α-methylstyrene-acrylic acid copolymer, a styrene-α-methylstyrene-acrylic acid-acrylic acid ester copolymer, and the like.

The vinyl chloride-based resin may be a vinyl chloride-vinyl acetate copolymer.

The polyolefin-based resin has an olefin such as ethylene, propylene, and butylene in the structural skeleton, and known ones can be appropriately selected and used.

As the inorganic particles, any inorganic particles may be used as long as the ink color is transparent in a state of being contained in the ink jet ink composition (for example, contained in an amount of 3% by mass with respect to the entire composition). The term “transparent” is a property of a substance through which light passes, and is a property in a state in which the transmittance is extremely high and the other side of the substance is visible through the substance. Examples of the inorganic particles (excluding the color material) include calcium carbonate, barium sulfate, titanium oxide, aluminum hydroxide, silica, glass, talc, mica, magnesium oxide, zinc oxide, and the like.

### 1.1.5 Other Components

The ink composition A may contain various additives such as a pH adjusting agent, a wax, a chelating agent, an antirust agent, an antifungal agent, an antioxidant, a reduction inhibitor, and an evaporation promoter, in addition to the above components, depending on the necessity. The other components may be a water-soluble substance being solid in an environment of 25° C. and 1 atmospheric pressure or a substance being liquid in an environment of 25° C. and 1 atmospheric pressure.

The pH adjusting agent is not particularly limited, and examples thereof include an appropriate combination of acid, base, weak acid, and weak base. As examples of the acids and the bases used in such a combination, inorganic acids such as sulfuric acid, hydrochloric acid, and nitric acid; inorganic bases such as lithium hydroxide, sodium hydroxide, potassium hydroxide, dihydrogen potassium phosphate, hydrogen disodium phosphate, potassium carbonate, sodium carbonate, hydrogen sodium carbonate, and ammonia; organic bases such as triethanol amine, diethanol amine, monoethanol amine, tripropanol amine, triisopropanol amine, diisopropanol amine, and tris(hydroxymethyl)aminomethane (THAM); and organic acids such as Good's buffers such as adipic acid, citric acid, succinic acid, lactic acid, N,N-bis(2-hydroxyethyl)-2-aminoethanesulfonic acid (BES), 4-(2-hydroxyethyl)-1-piperazineethanesulfonic acid (HEPES), morpholinoethanesulfonic acid (MES), carbamoylmethyl iminobisacetic acid (ADA), piperazine-1,4-bis(2-ethanesulfonic acid) (PIPES), N-(2-acetamide)-2-aminoethanesulfonic acid (ACES), cholamine chloride, N-tris (hydroxymethyl)methyl-2-aminoethanesulfonic acid (TES), acetamide glycine, tricine, glycine amide, and bicine, a phosphate buffer solution, a citrate buffer solution, a Tris buffer solution, and the like may be used.

A content when containing other components is preferably 0.1% to 5% by mass, more preferably 0.1% to 3% by mass, further more preferably 0.18 to 18 by mass, and particularly preferably 0.3% to 1% by mass, with respect to the total amount of the ink composition A.

### 1.1.6 Preparation Method

A method of preparing an ink composition A is not particularly limited, and may be a method of obtaining the ink composition A by mixing the above-mentioned components in any order, a method of obtaining the ink composition A mixing the above-mentioned components with a liquid medium such as water and then removing the liquid medium, and the like. The preferable preparation method of an ink composition A is to freeze-dry or spray-dry a mixture of the above-mentioned components with a liquid medium such as water.

In the case of freeze-drying and spray-drying, a surface area of the substance after drying is increased as compared with the case of natural drying and the like, and thus the resolubility/redispersibility tends to be excellent. In addition, since no heat is applied in the freeze-drying and a heating time is extremely short even in the spray-drying, a heat damage to the ink composition A can be reduced.

The freeze-drying can be performed using a known freeze-drying device. As the freeze-drying device, for example, “FD-1000” and the like manufactured by Tokyo Rikakikai Co., Ltd. can be used.

In the freeze-drying, it is preferable to include a preliminary freezing step and a freeze-drying step.

The preliminary freezing step is a step of cooling a sample with a low-temperature liquid. A temperature in the preliminary freezing step is not particularly limited, but is preferably from −70° C. to −200° C. Examples of the low-temperature liquid used in the preliminary freezing step include liquid nitrogen, liquid ethanol, liquid acetone, and the like.

The freeze-drying step is a step of vaporizing the liquid medium in the sample and freeze-drying the sample by reducing the pressure of the sample and leaving the sample for a predetermined time. The temperature at the time of the freeze-drying step is not particularly limited, but is preferably set to be lower than a collapse temperature of the sample to be freeze-dried, and is preferably −80° C. or higher. In addition, the pressure at the time of reduction of the pressure is not particularly limited, and is preferably 100 mmHg or less, and is most preferably 20 mmHg or less. The time of the freeze-drying step is not particularly limited, and is preferably 2 to 24 hours, and most preferably about 10 hours.

The spray-drying can be performed using a known spray drying device. As the spray drying device, for example, “ADL311S-A” and the like manufactured by Yamato Scientific Co., Ltd. can be used.

As a drying temperature in the spray-drying, an inlet temperature is preferably 150° C. to 220° C. and an outlet temperature is preferably 30° C. to 60° C., and the inlet temperature is more preferably 180° C. to 220° C. and the outlet temperature is more preferably 50° C. to 60° C.

### 1.1.7 Storage Aspect

The ink composition A is preferably stored in a container made of a material of which the water vapor permeability in an environment of a temperature of 20° C. and a humidity of 90% RH, measured in accordance with JIS K 7129, is 5 g/m²/day or less. In this case, the storage stability tends to be favorable, and the inactivation of the color material tends to be reduced.

The water vapor permeability in an environment of a temperature of 20° C. and a humidity of 90% RH, measured in accordance with JIS K 7129, is preferably 3 g/m²/day or less, and more preferably 2 g/m²/day or less.

As the material of which a water vapor permeability in an environment of a temperature of 20° C. and a humidity of 90% RH, measured in accordance with JIS K 7129, is 5 g/m²/day or less, for example, a laminate obtained by laminating a resin layer such as polyethylene terephthalate or polypropylene and a barrier layer such as an aluminum foil or an aluminum vapor deposition film is preferable.

The container preferably includes at least one or more of a mechanism for mixing and stirring the ink composition A and the aqueous solution B and a mechanism for heating the mixed ink composition A and aqueous solution B. As a result, the mixing step described later can be effectively performed, and the resolubility/redispersibility tends to be favorable.

At least one aspect of the mechanism for mixing and stirring will be described. The mechanism for mixing and stirring is provided below the container, preferably on a bottom surface of the container. The mechanism for mixing and stirring preferably includes a rotating blade, a rotating shaft, and a motor. The rotating blade is supported by a rotating shaft rotated by a motor, and the rotating blade is rotated by driving the motor.

At least one aspect of a mechanism for heating will be described. The mechanism for heating may be a heater that is in contact with the ink composition A and the aqueous solution B and directly heats the ink composition A and the aqueous solution B, or may be a heater that is attached to the outside of the container and indirectly heats the ink composition A and the aqueous solution B by heating the container. A temperature of the heater is not particularly limited, but is preferably, for example, 30° C. to 80° C., and more preferably 30° C. to 60° C.

A capacity of the container is preferably 20 L or less, and more preferably 10 L or less. When the capacity of the container is within the above range, the mixing step described later can be effectively performed, and the resolubility/redispersibility tends to be more favorable.

### 1.2 Aqueous Solution B Preparation Step

A method of using an ink according to an embodiment of the present disclosure includes an aqueous solution B preparation step of preparing an aqueous solution B. Hereinafter, each component contained in the aqueous solution B will be described.

The aqueous solution B contains water in an amount of 50% by mass or more with respect to a total amount of the aqueous solution B. As a result, intermittent printing stability can be favorable.

### 1.2.1 Water

The aqueous solution B contains water. The water is not particularly limited, and examples thereof include pure water such as ion-exchanged water, ultrafiltration water, reverse osmosis water, and distilled water, and ultrapure water in which ionic impurities are removed as much as possible. In addition, when water sterilized by ultraviolet irradiation, addition of hydrogen peroxide, or the like is used, the occurrence of mold or bacteria in the case of long-term storage of the aqueous solution B can be prevented.

A content of water is 50% by mass or more, but more preferably 60% by mass or more, further preferably 70% by mass or more, further more preferably 80% by mass or more, particularly preferably 90% by mass or more, more particularly preferably 95% by mass or more, and still more particularly preferably 100% by mass, with respect to a total amount of the aqueous solution B. In particular, when the aqueous solution B contains water in an amount of 60% by mass or more with respect to the total amount of the aqueous solution B, the intermittent printing stability tends to be more favorable.

### 1.2.2. Organic Solvent

The aqueous solution B may contain an organic solvent. Examples of the organic solvent include esters, alkylene glycol ethers, cyclic esters, amides, alcohols, polyhydric alcohols, and the like.

Examples of the esters include glycol monoacetates such as ethylene glycol monomethyl ether acetate, ethylene glycol monoethyl ether acetate, ethylene glycol monobutyl ether acetate, diethylene glycol monomethyl ether acetate, diethylene glycol monoethyl ether acetate, diethylene glycol monobutyl ether acetate, propylene glycol monomethyl ether acetate, dipropylene glycol monomethyl ether acetate, and methoxy butyl acetate, and glycol diesters such as ethylene glycol diacetate, diethylene glycol diacetate, propylene glycol diacetate, dipropylene glycol diacetate, ethylene glycol acetate propionate, ethylene glycol acetate butylate, diethylene glycol acetate butylate, diethylene glycol acetate propionate, diethylene glycol acetate butylate, propylene glycol acetate propionate, propylene glycol acetate butylate, dipropylene glycol acetate butylate, and dipropylene glycol acetate propionate.

The alkylene glycol ethers may be alkylene glycol monoethers or diethers, and are preferably alkyl ethers. Specific examples include alkylene glycol monoalkyl ethers such as ethylene glycol monomethyl ether, ethylene glycol monoethyl ether, ethylene glycol monoisopropyl ether, ethylene glycol monobutyl ether, diethylene glycol monomethyl ether, diethylene glycol monoethyl ether, diethylene glycol monobutyl ether, triethylene glycol monomethyl ether, triethylene glycol monoethyl ether, triethylene glycol monobutyl ether, tetraethylene glycol monomethyl ether, tetraethylene glycol monoethyl ether, tetraethylene glycol monobutyl ether, propylene glycol monomethyl ether, propylene glycol monoethyl ether, propylene glycol monopropyl ether, propylene glycol monobutyl ether, dipropylene glycol monomethyl ether, dipropylene glycol monoethyl ether, dipropylene glycol monopropyl ether, dipropylene glycol monobutyl ether, and tripropylene glycol monobutyl ether; alkylene glycol dialkyl ethers such as ethylene glycol dimethyl ether, ethylene glycol diethyl ether, ethylene glycol dibutyl ether, diethylene glycol dimethyl ether, diethylene glycol diethyl ether, diethylene glycol dibutyl ether, diethylene glycol methyl ethyl ether, diethylene glycol methyl butyl ether, triethylene glycol dimethyl ether, triethylene glycol diethyl ether, triethylene glycol dibutyl ether, triethylene glycol methyl butyl ether, tetraethylene glycol dimethyl ether, tetraethylene glycol diethyl ether, tetraethylene glycol dibutyl ether, propylene glycol dimethyl ether, propylene glycol diethyl ether, dipropylene glycol dimethyl ether, dipropylene glycol diethyl ether, and tripropylene glycol dimethyl ether; and the like.

Examples of cyclic esters include cyclic esters (lactones) such as β-propiolactone, γ-butyrolactone, δ-valerolactone, ε-caprolactone, β-butyrolactone, β-valerolactone, γ-valerolactone, β-hexanolactone, γ-hexanolactone, δ-hexanolactone, β-heptanolactone, γ-heptanolactone, δ-heptanolactone, ε-heptanolactone, γ-octanolactone, ε-octanolactone, ε-octanolactone, δ-nonalactone, ε-nonalactone, and ε-decanolactone; compounds in which a hydrogen of a methylene group adjacent to a carbonyl group thereof is substituted with an alkyl group having 1 to 4 carbon atoms, and the like.

Examples of the amides include cyclic amides, acyclic amides, and the like. Examples of the acyclic amides include alkoxyalkylamides and the like.

Examples of the cyclic amides include lactams. Examples of lactams include pyrrolidones such as 2-pyrrolidone, 1-methyl-2-pyrrolidone, 1-ethyl-2-pyrrolidone, 1-propyl-2-pyrrolidone, 1-butyl-2-pyrrolidone, and 1-(2-hydroxyethyl) pyrrolidin-2-one.

Examples of alkoxyalkylamides include 3-methoxy-N,N-dimethylpropionamide, 3-methoxy-N,N-diethylpropionamide, 3-methoxy-N,N-methylethylpropionamide, 3-ethoxy-N,N-dimethylpropionamide, 3-ethoxy-N,N-diethylpropionamide, 3-ethoxy-N,N-methylethylpropionamide, 3-n-butoxy-N,N-dimethylpropionamide, 3-n-butoxy-N,N-diethylpropionamide, 3-n-butoxy-N,N-methylethylpropionamide, 3-n-propoxy-N,N-dimethylpropionamide, 3-n-propoxy-N,N-diethylpropionamide, 3-n-propoxy-N,N-methylethylpropionamide, 3-iso-propoxy-N,N-dimethylpropionamide, 3-iso-propoxy-N,N-diethylpropionamide, 3-iso-propoxy-N,N-methylethylpropionamide, 3-tert-butoxy-N,N-dimethylpropionamide, 3-tert-butoxy-N,N-diethylpropionamide, 3-tert-butoxy-N,N-methylethylpropionamide, N,N-dimethylisobutyrate amide, and the like.

Examples of alcohols include a compound in which one hydrogen atom of alkane is substituted with a hydroxyl group. The alkane preferably has 10 or less carbon atoms, more preferably 6 or less carbon atoms, and further more preferably 3 or less carbon atoms. The number of carbon atoms of the alkane is 1 or more, and is preferably 2 or more. The alkane may be a linear type or a branched type. Examples of alcohols include methanol, ethanol, n-propyl alcohol, iso-propyl alcohol, n-butanol, 2-butanol, tert-butanol, iso-butanol, n-pentanol, 2-pentanol, 3-pentanol, tert-pentanol, 2-phenoxy ethanol, benzyl alcohol, phenoxy propanol, and the like.

Polyhydric alcohols have two or more hydroxyl groups in the molecule. The polyhydric alcohols can be divided into, for example, alkanediols and polyols.

Examples of alkanediols include compounds in which alkane is substituted with two hydroxyl groups. Examples of alkanediols include 1,2-alkanediol, which is a general term for compounds in which hydroxyl groups are substituted at the first and second positions of alkanes, and other alkanediols other than 1, 2-alkanediol.

Examples of the 1, 2-alkanediol include ethylene glycol, 1,2-propanediol (propylene glycol), 1, 2-butanediol (1,2BD), 1,2-pentanediol (1,2PD), 1,2-hexanediol (1,2HD), 1, 2-heptanediol, 1, 2-octanediol, 1, 2-nonanediol, 1,2-decanediol, 3-methyl-1, 2-butanediol, 3-methyl-1, 2-pentanediol, 4-methyl-1,2-pentanediol, 3,4-dimethyl-1, 2-pentanediol, 3-ethyl-1, 2-pentanediol, 4-ethyl-1, 2-pentanediol, 3-methyl-1, 2-hexanediol, 4-methyl-1, 2-hexanediol, 5-methyl-1, 2-hexanediol, 3, 4-dimethyl-1, 2-hexanediol, 3,5-dimethyl-1, 2-hexanediol, 4, 5-dimethyl-1, 2-hexanediol, 3-ethyl-1, 2-hexanediol, 4-ethyl-1, 2-hexanediol, and 3-ethyl-4-methyl-1, 2-hexanediol.

Examples of other alkanediols include 1,3-propanediol, 1,3-butylene glycol (also known as 1,3-butanediol), 1,4-butanediol, 2, 3-butanediol, 1,5-pentanediol, 2, 4-pentanediol, 2-methyl-1, 3-propanediol, 3-methyl-1,3-butanediol, 3-methyl-1,5-pentanediol, 2-ethyl-1, 3-hexanediol, 2-methyl-1, 3-pentanediol, 3-methyl-1, 5-pentanediol, 2-methylpentane-2, 4-diol, 1,6-hexanediol, 2-ethyl-2-methyl-1, 3-propanediol, 2-methyl-2-propyl-1, 3-propanediol, and the like.

Examples of the polyols include a condensate in which two or more molecules of alkanediols are intermolecularly condensed between hydroxyl groups, a compound having three or more hydroxyl groups, and the like.

Examples of the condensate in which two or more molecules of alkanediols are intermolecularly condensed between hydroxyl groups include dialkylene glycol such as diethylene glycol and dipropylene glycol, trialkylene glycol such as triethylene glycol and tripropylene glycol, and the like.

The compound having three or more hydroxyl groups is a compound having three or more hydroxyl groups having an alkane or polyether structure as a skeleton. Examples of the compound having three or more hydroxyl groups include glycerin, trimethylolethane, trimethylolpropane, 1, 2, 5-hexanetriol, 1, 2, 6-hexanetriol, pentaerythritol, polyoxypropylenetriol, and the like.

The organic solvent may be used alone or in combination of two or more thereof.

The aqueous solution B preferably contains a water-soluble organic solvent among the organic solvents. When the water-soluble organic solvent is contained, the wettability with respect to the ink composition A becomes favorable, and the resolubility/redispersibility tends to be more excellent. The “water-soluble” in the water-soluble organic solvent is the same as the “water-soluble” in the above-described color material.

As the water-soluble organic solvent, it is preferable to contain one or more selected from glycerin, 1-(2-hydroxyethyl) pyrrolidin-2-one, triethylene glycol, and triethylene glycol monobutyl ether. When such a water-soluble organic solvent is contained, the resolubility/redispersibility tends to be more excellent.

A content of the organic solvent is preferably 50% by mass or less, more preferably less than 50% by mass, further more preferably 10% to 45% by mass, particularly preferably 20% to 45% by mass, and more particularly preferably 30% to 45% by mass, with respect to the total amount of the aqueous solution B.

The aqueous solution B preferably contains an organic solvent having a standard boiling point of higher than 280° C. in an amount of 5% by mass or more, more preferably 10% by mass or more, further more preferably 15% by mass or more, and particularly preferably 208 by mass or more, with respect to the total amount of the aqueous solution B. As a result, the resolubility/redispersibility tends to be more excellent. Examples of the organic solvent having a standard boiling point of higher than 280° C. include triethylene glycol, glycerin, and the like.

### 1.2.3 Surfactant

The aqueous solution B may contain a surfactant. As the surfactant, in addition to the above-mentioned surfactant, a liquid surfactant may be included in an environment of 25° C. and 1 atmospheric pressure. Examples of the liquid surfactant in an environment of 25° C. and 1 atmospheric pressure include OLFINE PD-002W (acetylene glycol-based surfactant, product name manufactured by Nissin Chemical Industry Co., Ltd.), BYK-348 (silicone-based surfactant, product name manufactured by BYK), SURFLON S-241 (fluorine-based surfactant, product name manufactured by AGC Seimi Chemical Co., Ltd.), and the like.

A content of the surfactant is preferably 0.1% to 5% by mass, more preferably 0.1% to 3% by mass, further more preferably 0.3% to 2% by mass, and particularly preferably 0.3% to 1% by mass, with respect to the total amount of the aqueous solution B.

### 1.2.4 Other Components

The aqueous solution B may contain various additives such as a resin, a wax, a chelating agent, an antirust agent, a antifungal agent, an antioxidant, and a reduction inhibitor, in addition to the above components, depending on the necessity.

### 1.2.5 Preparation Method

The method of preparing an aqueous solution B is not particularly limited, and the aqueous solution B is obtained by mixing the above-mentioned components in any order and removing impurities by filtration and the like depending on the necessity. As a method of mixing each component, a method of sequentially adding materials to a container equipped with a stirrer such as a mechanical stirrer and a magnetic stirrer and stirring and mixing thereof is suitably used. As a filtration method, centrifugal filtration, filter filtration, and the like can be performed, depending on the necessity.

### 1.3 Mixing Step

A method of using an ink according to an embodiment of the present disclosure includes a mixing step of mixing the above-described ink composition A and the aqueous solution B when used in an ink jet printer. As a result, the environmental load due to transportation and the storage space can be minimized.

The mixing step is a step performed in association with the use of the ink jet printer, and may be performed immediately before the use of the ink jet printer or during the use of the ink jet printer.

Immediately before the use of the ink jet printer means, for example, within 1 week before using the ink jet printer, within 3 days before using the ink jet printer, within 1 day before using the ink jet printer, within 12 hours before using the ink jet printer, within 6 hours before using the ink jet printer, within 3 hours before using the ink jet printer, within 1 hour before using the ink jet printer, within 30 minutes before using the ink jet printer, within 15 minutes before using the ink jet printer, or within 5 minutes before using the ink jet printer.

The mixing step may be performed in the ink jet printer, or may be performed in a container separated from the ink jet printer. The mixing step may be performed at a location within 100 m, within 50 m, within 25 m, within 10 m, within 5 m, or within 1 m from the ink jet printer.

The method of mixing the ink composition A and the aqueous solution B is not particularly limited, and for example, the ink composition A and the aqueous solution B may be added to a container equipped with a stirrer and stirred and mixed.

A ratio at which the ink composition A and the aqueous solution B are mixed can be appropriately adjusted according to the purpose, but for example, a mass ratio of the ink composition A to the aqueous solution B (ink composition A/aqueous solution B) is preferably 0.25 to 1.5, more preferably 0.25 to 1.2, further more preferably 0.25 to 1.0, and particularly preferably 0.3 to 0.9.

The ink jet ink composition C obtained by the mixing step has a surface tension of 40 mN/m or less and a viscosity of 100 mPa·s or less. As a result, the resolubility/redispersibility and intermittent printing stability can be made favorable.

The surface tension of the ink jet ink composition C is 40 mN/m or less, preferably 38 mN/m or less, more preferably 36 mN/m or less, and particularly preferably 35 mN/m or less. A lower limit of the surface tension is not particularly limited, but is preferably 25 mN/m or more, and more preferably 30 mN/m or more.

A viscosity of the ink jet ink composition C is 100 mPa·s or less, preferably 50 mPa·s or less, more preferably 30 mPa·s or less, further more preferably 15 mPa·s or less, particularly preferably 10 mPa·s or less, and more particularly preferably 5 mPa·s or less.

### 1.4 Ink Jet Printer

The method of using the ink according to an embodiment of the present disclosure is to use the above-described ink jet ink composition C by ejecting the ink jet ink composition C from an ink jet printer. Hereinafter, the ink jet printer will be described with reference to the drawings.

It is preferable that the ink jet printer has an ink jet head that includes a nozzle for ejecting the ink jet ink composition, a pressure chamber to which the ink jet ink composition is supplied, and a circulation flow path that allows the ink jet ink composition in the pressure chamber to be circulated. As a result, the intermittent printing stability tends to be more favorable.

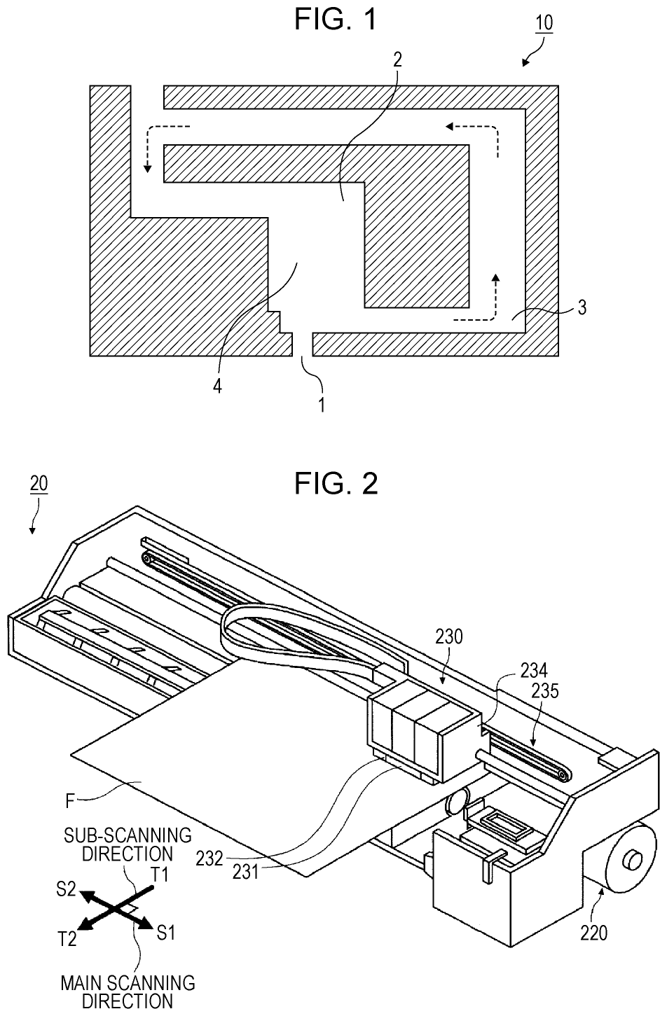

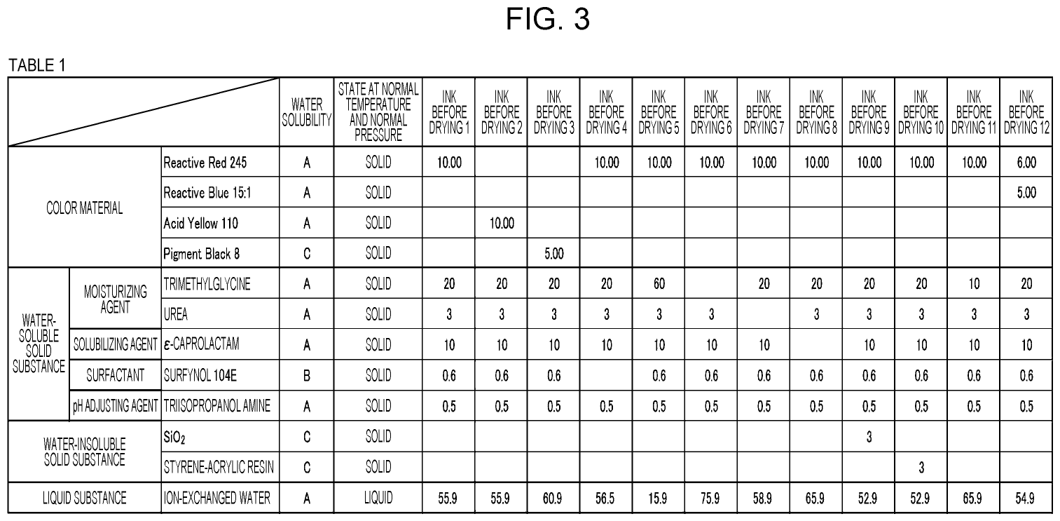

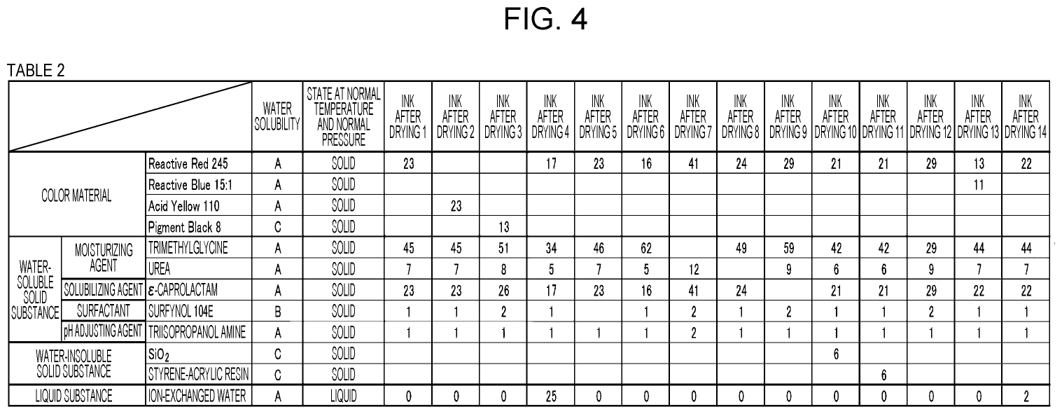

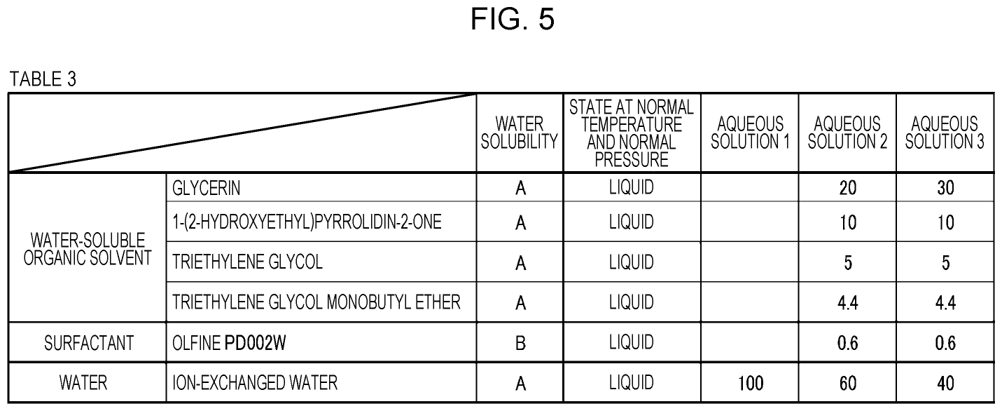

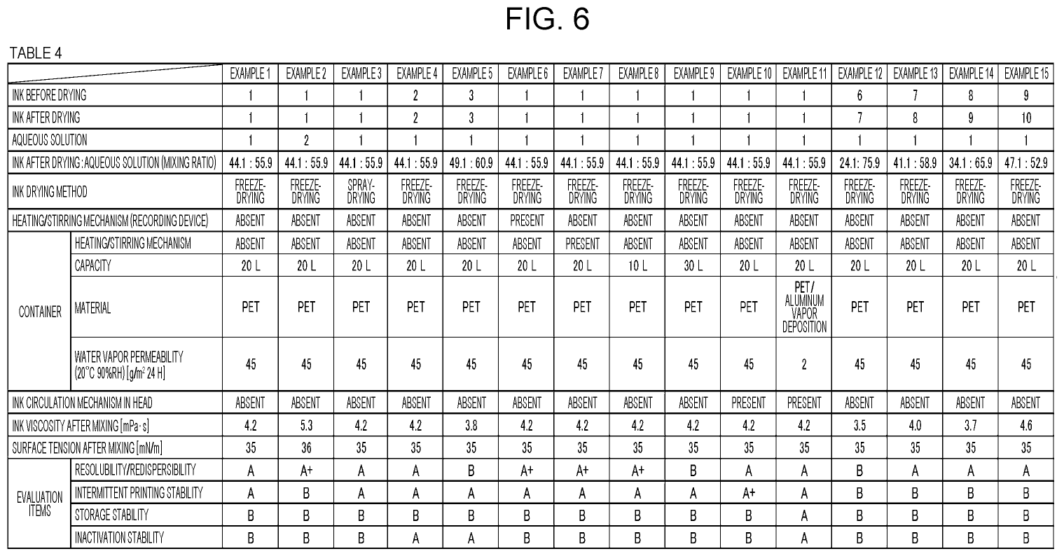

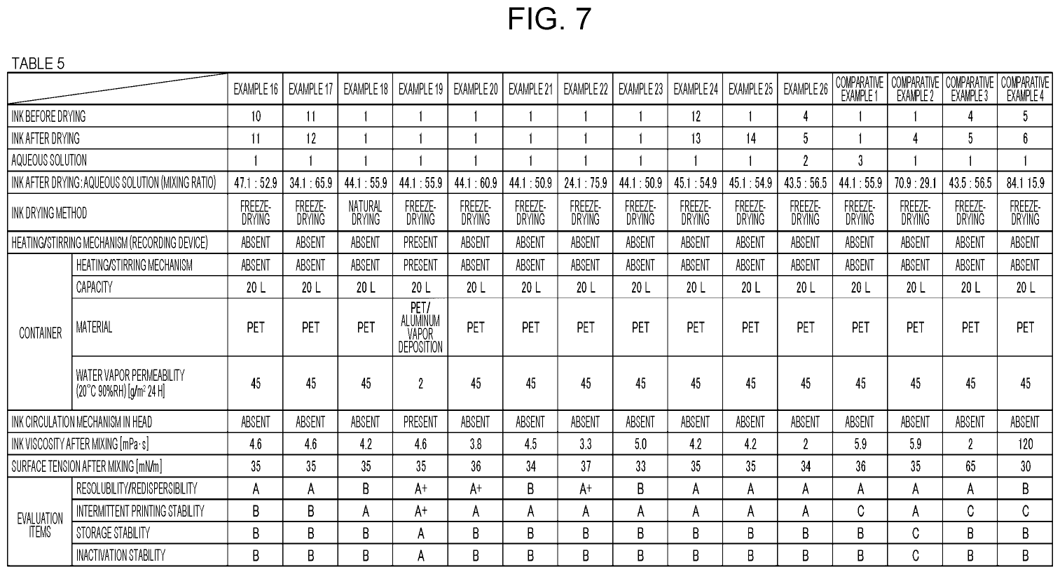

As illustrated in FIG. 1, an ink jet head 10 includes a nozzle 1, a pressure chamber 2 to which the ink jet ink composition is supplied, and a circulation flow path 3 that allows the ink jet ink composition in the pressure chamber 2 to be circulated. In the example of FIG. 1, the nozzle 1 and the pressure chamber 2 communicate with each other through a communication path 4.

The nozzle 1 is a through-hole for ejecting the ink jet ink composition. More specifically, the nozzle 1 is a through-hole formed in a nozzle plate. A plurality of nozzles is formed in the nozzle plate, and the pressure chamber 2 is provided for each of the nozzles. The pressure chamber 2 is individually formed for each nozzle 1. The ink jet ink composition is supplied to the pressure chamber 2. When a pressure in the pressure chamber 2 fluctuates due to a pressure generating unit (not illustrated), a part of the ink jet ink composition flowing in the communication path 4 is ejected from the nozzle 1 to the outside, and a remaining part flows into the circulation flow path 3. A route of the circulation flow path 3 is not particularly limited, but the flow path can be configured such that the ink jet ink composition flowing into the circulation flow path 3 is supplied to the pressure chamber 2. The ink jet ink composition flowing into the circulation flow path 3 does not necessarily have to be resupplied to the same pressure chamber, and may be supplied to a pressure chamber corresponding to another nozzle. In addition, it is not necessary that all the flow paths of the circulation flow path 3 are inside the ink jet head 10, and some of the flow paths may be outside the ink jet head 10 as long as the flow paths are configured such that the ink jet ink composition flowing out from the pressure chamber 2 is supplied to the pressure chamber 2 again.

As described above, according to the ink jet head 10 of the present embodiment, the ink jet ink composition in the pressure chamber 2, more specifically, the ink jet ink composition in the vicinity of the nozzle 1 can be efficiently circulated in the head. As a result, the intermittent printing stability tends to be more favorable.

Examples of the ink jet head 10 include a line head that performs recording by a line method and a serial head that performs recording by a serial method.

In the line method using a line head, for example, an ink jet head having a width equal to or larger than a recording width of a recording medium is fixed to the ink jet printer. Then, the recording medium is moved along a sub-scanning direction (vertical direction of recording medium, transport direction), ink droplets are ejected from the nozzles of the ink jet head in conjunction with the movement, and thereby an image is recorded on the recording medium.

In the serial method using a serial head, for example, an ink jet head is mounted on a carriage that can move in a width direction of a recording medium. Then, the carriage is moved along a main scanning direction (lateral direction or width direction of recording medium), and ink droplets are ejected from nozzle openings of the head in conjunction with the movement, and thereby an image can be recorded on the recording medium.

Therefore, the recording medium is not particularly limited, and examples thereof include a liquid absorptive recording medium such as paper, film, and fabric, a liquid low-absorptive recording medium such as printed paper, a liquid non-absorptive recording medium such as metal, glass, and polymer, and the like. In addition, the form of the recording medium is not particularly limited. Examples thereof include a film, a board, a fabric, and the like.

The ink jet head 10 may have a heating portion that enables heating the ink jet ink composition. More specifically, the ink jet head 10 may have a heating portion that heats the ink jet ink composition in the circulation flow path configured by the pressure chamber 2, the circulation flow path 3, and the communication path 4. A heating unit is not particularly limited, and can be provided in the pressure chamber 2, the circulation flow path 3, or the communication path 4, for example. In addition, a heating unit that heats a nozzle plate may be provided, and when the circulation flow path 3 passes through the outside of the ink jet head 10, the heating unit may be provided in the circulation flow path 3 existing outside the ink jet head 10. Furthermore, a heating unit may be provided in an ink flow path upstream of a pressure chamber. Here, the ink flow path refers to a flow path for allowing an ink to flow. The ink flow path includes, for example, an ink supply path for supplying an ink from an ink accommodating container that stores the ink to the ink jet head.

A heating temperature of the composition is preferably 35° C. or higher, more preferably 40° C. or higher, and further more preferably 45° C. or higher as the lower limit. In addition, as the upper limit, the heating temperature of the composition is preferably 70° C. or lower, more preferably 60° C. or lower, and further more preferably 50° C. or lower.

The ink jet printer preferably includes at least one or more of a mechanism for mixing and stirring the ink composition A and the aqueous solution B and a mechanism for heating the mixed ink composition A and the aqueous solution B. As a result, the above-mentioned mixing step can be effectively performed, and the resolubility/redispersibility tends to be more favorable.

At least one aspect of the mechanism for mixing and stirring will be described. It is preferable that the mechanism for mixing and stirring is provided below an ink accommodating container of the ink jet printer, preferably on a bottom surface of the ink accommodating container. The mechanism for mixing and stirring preferably includes a rotating blade, a rotating shaft, and a motor. The rotating blade is supported by a rotating shaft rotated by a motor, and the rotating blade is rotated by driving the motor.

At least one aspect of a mechanism for heating will be described. The mechanism for heating may be a heater that is in contact with the ink composition A and the aqueous solution B and directly heats the ink composition A and the aqueous solution B, or may be a heater that is attached to the outside of the ink accommodating container and indirectly heats the ink composition A and the aqueous solution B by heating the ink accommodating container. A temperature of the heater is not particularly limited, but is preferably, for example, 30° C. to 80° C., and more preferably 30° C. to 60° C.

As an example of the ink jet printer, FIG. 2 illustrates a perspective view of a serial printer. As illustrated in FIG. 2, a serial printer 20 is provided with a transport portion 220 and a recording portion 230. The transport portion 220 transports a recording medium F fed to the serial printer to the recording portion 230, and discharges the recording medium after recording to the outside of the serial printer. Specifically, the transport portion 220 includes each feeding roller and transports the fed recording medium F in the sub-scanning direction T1.

In addition, the recording portion 230 includes an ink jet head 231 that ejects a composition to the recording medium F fed from the transport portion 220, a carriage 234 on which the ink jet head 231 is mounted, and a carriage movement mechanism 235 that moves the carriage 234 in the main scanning directions S1 and S2 of the recording medium F.

In the case of the serial printer, a head having a length smaller than a width of the recording medium is provided as the ink jet head 231, the head moves, and recording is performed in a plurality of passes (multi-pass). In addition, in the serial printer, the ink jet head 231 is mounted on the carriage 234 that moves in a predetermined direction, and the head moves in accordance with the movement of the carriage to eject the composition onto a recording medium. As a result, recording is performed in two or more passes (multi-pass). The pass is also referred to as main scanning. Sub-scanning that transports the recording medium is performed between a pass and a pass. That is, the main scanning and the sub-scanning are alternately performed.

The ink jet printer is not limited to the above-mentioned serial type printer, and may be the above-mentioned line type printer.

### 2. Ink Set

According to an embodiment of the present disclosure, there is provided an ink set including an ink composition A, which contains a color material and a water-soluble substance being solid in an environment of 25° C. and 1 atmospheric pressure, in which a content of a substance being liquid in an environment of 25° C. and 1 atmospheric pressure is 20% by mass or less with respect to a total amount of the ink composition A, and an aqueous solution B, which contains water in an amount of 50% by mass or more with respect to a total amount of the aqueous solution B, in which the ink composition A and the aqueous solution B are used by being mixed such that a surface tension is 40 mN/m or less and a viscosity is 100 mPa·s or less.

According to the ink set according to the present embodiment, the dry ink composition and the water-soluble solution can be mixed immediately before use in the ink jet printer to be converted into an ink jet ink, and thus the environmental load due to transportation and the storage space can be minimized. In addition, the dry ink composition can obtain favorable resolubility/redispersibility by containing a color material and a water-soluble solid substance, and the water-soluble solution can obtain favorable intermittent printing stability by containing water in an amount of 50% by mass or more with respect to a total amount of the water-soluble solution. In addition, by setting a surface tension and a viscosity of the ink jet ink composition after the mixing to predetermined values, the ink jet ejection can be made stable.

In the present disclosure, the term “ink set” is a set of inks obtained by combining at least the ink composition A and the aqueous solution B. The ink set is a set of inks that are mixed and used. The number of the ink compositions included in the ink set may be only one, or may be two or more. The same applies to the aqueous solution included in the ink set.

The ink composition A and the aqueous solution B included in the ink set according to the present embodiment are as described above, and thus the description thereof will be omitted.

### 3. Method for Producing Ink Jet Ink Composition

According to an embodiment of the present disclosure, there is provided a method of producing an ink jet ink composition, including: mixing an ink composition A, which contains a color material and a water-soluble substance being solid in an environment of 25° C. and 1 atmospheric pressure, in which a content of a substance being liquid in an environment of 25° C. and 1 atmospheric pressure is 20% by mass or less with respect to a total amount of the ink composition A, with an aqueous solution B, which contains water in an amount of 50% by mass or more with respect to a total amount of the aqueous solution B, when used in an ink jet printer, in which the ink jet ink composition has a surface tension of 40 mN/m or less and a viscosity of 100 mPa·s or less.

According to the method of producing an ink jet ink composition according to the present embodiment, the dry ink composition and the water-soluble solution can be mixed immediately before use in an ink jet printer to be converted into an ink jet ink, and thus an environmental load due to transportation and a storage space can be minimized. In addition, the dry ink composition can obtain favorable resolubility/redispersibility by containing a color material and a water-soluble solid substance, and the water-soluble solution can obtain favorable intermittent printing stability by containing water in an amount of 50% by mass or more with respect to a total amount of the water-soluble solution. In addition, by setting a surface tension and a viscosity of the ink jet ink composition after the mixing to predetermined values, the ink jet ejection can be made stable.

The ink composition A and the aqueous solution B used in the production method according to the present embodiment are as described above, and the step of mixing is the same as the above-described mixing step, and thus the description thereof will be omitted.

### 4. Ink Jet Ink Composition

According to an embodiment of the present disclosure, there is provided an ink jet ink composition including an ink composition A, which contains a color material and a water-soluble substance being solid in an environment of 25° C. and 1 atmospheric pressure, in which a content of a substance being liquid in an environment of 25° C. and 1 atmospheric pressure is 20% by mass or less with respect to a total amount of the ink composition A, and an aqueous solution B, which contains water in an amount of 50% by mass or more with respect to a total amount of the aqueous solution B, in which the ink jet ink composition has a surface tension of 40 mN/m or less and a viscosity of 100 mPa·s or less.

According to the ink jet ink composition according to the present embodiment, the dry ink composition and the water-soluble solution can be mixed immediately before use in an ink jet printer, and thus an environmental load due to transportation and a storage space can be minimized. In addition, the dry ink composition can obtain favorable resolubility/redispersibility by containing a color material and a water-soluble solid substance, and the water-soluble solution can obtain favorable intermittent printing stability by containing water in an amount of 50% by mass or more with respect to a total amount of the water-soluble solution. In addition, by setting a surface tension and a viscosity of the ink jet ink composition after the mixing to predetermined values, the ink jet ejection can be made stable.

The ink composition A and the aqueous solution B forming the ink jet ink composition according to the present embodiment are as described above, and thus the description thereof will be omitted.

A ratio of the ink composition A to the aqueous solution B can be appropriately adjusted according to the purpose, but for example, a mass ratio of the ink composition A to the aqueous solution B (ink composition A/aqueous solution B) is preferably 0.25 to 1.5, more preferably 0.25 to 1.2, further more preferably 0.25 to 1.0, and particularly preferably 0.3 to 0.9.

### 5. Example

Hereinafter, the present disclosure will be described in more detail with reference to examples, but the present disclosure is not limited to these examples. Hereinafter, “%” is based on mass unless otherwise specified.

### 5.1 Preparation of Ink Composition

Each component was put into a container so as to have the composition shown in Table 1, mixed and stirred for 2 hours with a magnetic stirrer, then sufficiently mixed by performing a dispersion treatment with a bead mill filled with zirconia beads having a diameter of 0.3 mm, then stirred for 1 hour, and then filtered using a 5 μm PTFE membrane filter to obtain each ink before drying.

The color material used for preparing an ink 3 before drying was mixed with water at a mass ratio of 2:1 (pigment:pigment dispersant) with a pigment dispersant (not shown in table), which is water-soluble styrene-acrylic resin, in advance, and sufficiently stirred to prepare a pigment dispersion, and the pigment dispersion was used for preparing the ink. In addition, the column of the color material describes the mass % of the pigment converted from the solid content concentration of the pigment dispersion.

Each of the obtained inks before drying was dried using the ink drying methods described in Tables 4 and 5 to obtain each of the inks after drying described in Table 2.

Specifically, 30 g of an ink before drying was put into a 50 ml screw tube and freeze-drying was performed at a trap cooling temperature of −45° C. for 10 hours (when drying was not completed, the time was added) by using a device having a model number of “FD-1000” (manufactured by Tokyo Rikakikai Co., Ltd.) to obtain each of the inks after drying.

In addition, spray-drying was performed under conditions of an inlet temperature of 200° C. and an outlet temperature of 60° C. using a device having a model number of “ADL311S-A” (manufactured by Yamato Scientific Co., Ltd.) and an organic solvent recovery device “GAS410” (manufactured by Yamato Scientific Co., Ltd.) to obtain an ink 1 after drying according to Example 3.

In addition, natural drying was performed by leaving the ink in an open state in an environment of 25° C. and 40% RH for 30 days to obtain the ink 1 after drying according to Example 18.

Tables 1 and 2 will be described below.
SURFYNOL 104E (product name manufactured by Air Products & Chemicals, Inc., acetylene glycol-based surfactant)
Styrene-acrylic resin (product name “FS-102”, manufactured by NIPPON PAINT INDUSTRIAL COATINGS Co., Ltd.)

### 5.2 Preparation of Aqueous Solution

Each component was put into a container so as to have the composition shown in Table 3, and sufficiently mixed to obtain each aqueous solution.

Table 3 will be described below.
OLFINE PD002W (product name manufactured by Nissin Chemical Industry Co., Ltd., acetylene glycol-based surfactant)

### 5.3 Preparation of Ink Jet Ink Composition

The ink after drying and aqueous solution obtained above were mixed at the combinations and mixing ratios of Tables 4 and 5 to obtain an ink jet ink composition according to each example. Specifically, the ink after drying and the aqueous solution were put into the containers described in Tables 4 and 5, when the containers have heating/stirring mechanisms, mixing and stirring were performed at 60° C. and a stirring speed of 350 rpm for 1 hour, and when the containers do not have heating/stirring mechanisms, mixing and stirring were performed manually using a stirring rod to obtain an ink jet ink composition according to each example.

In Example 6, the ink after drying and the aqueous solution were directly put into an ink tank that enables putting, heating, and stirring a liquid and an ink tank of an ink jet printer “PX-G930” manufactured by Seiko Epson Corporation, which was modified to supply the ink composition to a print head from the ink tank, and mixed and stirred at 60° C. and a stirring speed of 350 rpm for 1 hour to obtain an ink jet ink composition.

In addition, in Example 19, the ink after drying and the aqueous solution were put into a container, mixed and stirred at 60° C. and a stirring speed of 350 rpm for 1 hour, then the composition in the container was put into the ink jet printer “PX-G930” manufactured by Seiko Epson Corporation, which was modified as described above, and mixed and stirred at 60° C. and a stirring speed of 350 rpm for 1 hour to obtain an ink jet ink composition.

For the obtained ink jet ink composition according to each example, a surface tension was measured by the Wilhelmy method using a surface tension meter (DY-300, manufactured by Kyowa Interface Science Co., Ltd.), and a viscosity was measured in accordance with JIS Z8809 using a vibration type viscometer (VM-100, manufactured by SEKONIC CORPORATION). The results were described in Tables 4 and 5.

### 5.4 Evaluation Method

### 5.4.1 Resolubility/Redispersibility

A peak value of an absorbance of the ink after drying obtained above at a visible light region was set to 100% (in case of color material having no peak, value at wavelength of 500 nm was set to 100%), a peak value of an absorbance of the ink jet ink composition obtained above was similarly measured to obtain a value of (peak value of ink jet ink composition)/(peak value of ink before drying), and the resolubility/redispersibility was evaluated based on the following determination criteria.

### Determination Criteria

A+: 98% or more
A: 95% or more and less than 98%
B: 90% or more and less than 95%
C: less than 95%

### 5.4.2 Intermittent Printing Stability

The ink jet ink composition obtained above was filled in an ink jet printer “PX-G930” manufactured by Seiko Epson Corporation, the ink jet head was allowed to idle for 2 minutes in an environment of 40° C. and 20% RH, and then a proportion of nozzles that could not be normally ejected was obtained, and the intermittent printing stability was evaluated based on the following determination criteria.

### Determination Criteria

A+: less than 5%
A: 5% or more and less than 10%
B: 10% or more and less than 20%
C: 25% or more

### 5.4.3 Storage Stability

The ink after drying obtained above was left at 30° C. and 90% RH for 3 hours in a state of being put in the container described in Tables 4 and 5, and a rate of increase in an amount of moisture calculated from a difference in weight before and after the leaving was obtained, and the storage stability was evaluated based on the following determination criteria.

### Determination Criteria

A: 0.5% or less
B: more than 0.5% and 1% or less
C: more than 1%

### 5.4.4 Inactivation Stability

An ink jet ink composition was obtained in the same manner as in “5.3 Preparation of ink jet ink composition” except that the ink after drying obtained above was left in a container form at 60° C. and 50% RH for 10 days. A printed matter was prepared using the ink jet ink composition (reactive dye: Cotton, acid dye: Silk, pigment: polyester), a color development difference ΔEcmc2:1 with the printed matter prepared in the same manner using the ink after drying without leaving at 60° C. and 50% RH for 10 days was obtained, and the inactivation stability was evaluated based on the following determination criteria.

### Determination Criteria

A: 4 or more
B: 2 or more and less than 4
C: less than 2

### 5.4.5 Water Solubility

For the water solubility described in Tables 1 to 3, a degree of solubility in water was evaluated based on the following determination criteria.

### Determination Criteria

A: 5 wt % or more
B: greater than 0 wt % and less than 5 wt %
C: insoluble 0 wt %

### 5.5 Evaluation Results

The evaluation results were shown in Tables 4 and 5. In each example according to a method of using an ink, including: mixing an ink composition A, which contains a color material and a water-soluble substance being solid in an environment of 25° C. and 1 atmospheric pressure, in which a content of a substance being liquid in an environment of 25° C. and 1 atmospheric pressure is 20% by mass or less with respect to a total amount of the ink composition A, with an aqueous solution B, which contains water in an amount of 50% by mass or more with respect to a total amount of the aqueous solution B, when used in an ink jet printer, to obtain an ink jet ink composition C having a surface tension of 40 mN/m or less and a viscosity of 100 mPa·s or less after the mixing, and using the ink jet ink composition C by ejecting thereof from the ink jet printer, all of resolubility/redispersibility, intermittent printing stability, and storage stability were excellent.

On the other hand, in the method of using an ink according to each of the comparative examples that does not satisfy the above-mentioned configuration, at least one of resolubility/redispersibility, intermittent printing stability, and storage stability was inferior.

The following content is derived from the above-described embodiment.

One aspect of a method of using an ink includes: mixing an ink composition A, which contains a color material and a water-soluble substance being solid in an environment of 25° C. and 1 atmospheric pressure, in which a content of a substance being liquid in an environment of 25° C. and 1 atmospheric pressure is 20% by mass or less with respect to a total amount of the ink composition A, with an aqueous solution B, which contains water in an amount of 50% by mass or more with respect to a total amount of the aqueous solution B, when used in an ink jet printer, to obtain an ink jet ink composition C having a surface tension of 40 mN/m or less and a viscosity of 100 mPa·s or less after the mixing, and using the ink jet ink composition C by ejecting the ink jet ink composition C from the ink jet printer.

In an aspect of the method of using an ink, the color material may be a water-soluble color material.

In any aspect of the method of using an ink, the color material may be a dye.

In any aspect of the method of using an ink, the color material may be a reactive dye.

In any aspect of the method of using an ink, the water-soluble substance being solid in an environment of 25° C. and 1 atmospheric pressure may be one or more selected from a moisturizing agent, a surfactant, and a solubilizing agent.

In any aspect of the method of using an ink, the water-soluble substance being solid in an environment of 25° C. and 1 atmospheric pressure may be one or more selected from trimethylglycine, urea, and ε-caprolactam.

In any aspect of the method of using an ink, in the ink composition A, a content of a water-insoluble substance being solid in an environment of 25° C. and 1 atmospheric pressure other than the color material may be 18 by mass or less with respect to the total amount of the ink composition A.

In any aspect of the method of using an ink, a content of the color material may be 35% by mass or less with respect to the total amount of the ink composition A.

In any aspect of the method of using an ink, the ink composition A may be produced by freeze-drying or spray-drying.

In any aspect of the method of using an ink, the aqueous solution B may contain water in an amount of 60% by mass or more with respect to the total amount of the aqueous solution B.

In any aspect of the method of using an ink, the aqueous solution B may further contain a water-soluble organic solvent.

In any aspect of the method of using an ink, the ink jet printer may include at least one or more of a mechanism for mixing and stirring the ink composition A and the aqueous solution B, and a mechanism for heating the mixed ink composition A and aqueous solution B.

In any aspect of the method of using an ink, the ink composition A may be stored in a container made of a material of which a water vapor permeability in an environment of a temperature of 20° C. and a humidity of 90% RH, measured in accordance with JIS K 7129, is 5 g/m²/day or less.

In an aspect of the method of using an ink, the container may include at least one or more of a mechanism for mixing and stirring the ink composition A and the aqueous solution B and a mechanism for heating the mixed ink composition A and aqueous solution B.

In any aspect of the method of using an ink, a capacity of the container may be 20 L or less.

In any aspect of the method of using an ink, the ink jet printer may include an ink jet head that includes a nozzle for ejecting the ink jet ink composition C, a pressure chamber to which the ink jet ink composition C is supplied, and a circulation flow path that allows the ink jet ink composition C in the pressure chamber to be circulated.

According to an aspect, there is provided an ink set including: an ink composition A, which contains a color material and a water-soluble substance being solid in an environment of 25° C. and 1 atmospheric pressure, in which a content of a substance being liquid in an environment of 25° C. and 1 atmospheric pressure is 208 by mass or less with respect to a total amount of the ink composition A; and an aqueous solution B, which contains water in an amount of 50% by mass or more with respect to a total amount of the aqueous solution B, in which the ink composition A and the aqueous solution B are used by being mixed such that a surface tension is 40 mN/m or less and a viscosity is 100 mPa·s or less.

According to an aspect, there is provided a method of producing an ink jet ink composition, the method including: mixing an ink composition A, which contains a color material and a water-soluble substance being solid in an environment of 25° C. and 1 atmospheric pressure, in which a content of a substance being liquid in an environment of 25° C. and 1 atmospheric pressure is 20% by mass or less with respect to a total amount of the ink composition A, with an aqueous solution B, which contains water in an amount of 50% by mass or more with respect to a total amount of the aqueous solution B, when used in an ink jet printer, in which the ink jet ink composition has a surface tension of 40 mN/m or less and a viscosity of 100 mPa·s or less.

According to an aspect, there is provided an ink jet ink composition including: an ink composition A, which contains a color material and a water-soluble substance being solid in an environment of 25° C. and 1 atmospheric pressure, in which a content of a substance being liquid in an environment of 25° C. and 1 atmospheric pressure is 20% by mass or less with respect to a total amount of the ink composition A; and an aqueous solution B, which contains water in an amount of 50% by mass or more with respect to a total amount of the aqueous solution B, in which the ink jet ink composition has a surface tension of 40 mN/m or less and a viscosity of 100 mPa·s or less.

The present disclosure is not limited to the above-described embodiment, and various modifications are possible. For example, the present disclosure includes a configuration substantially the same as the configuration described in the embodiment, for example, a configuration having the same function, method, and result, or a configuration having the same object and effect. In addition, the present disclosure also includes a configuration in which a non-essential part of the configuration described in the embodiment is replaced. In addition, the present disclosure includes a configuration that exhibits the same effects as the configuration described in the embodiment or a configuration that can achieve the same object. In addition, the present disclosure includes a configuration in which a known technique is added to the configuration described in the embodiment.

What is claimed is:

1. A method of using an ink, the method comprising:
mixing an ink composition A, which contains a color material and a water-soluble substance being solid in an environment of 25° C. and 1 atmospheric pressure, in which a content of a substance being liquid in an environment of 25° C. and 1 atmospheric pressure is 20% by mass or less with respect to a total amount of the ink composition A, with an aqueous solution B, which contains water in an amount of 50% by mass or more with respect to a total amount of the aqueous solution B, when used in an ink jet printer, to obtain an ink jet ink composition C having a surface tension of 40 mN/m or less and a viscosity of 100 mPa·s or less after the mixing; and
using the ink jet ink composition C by ejecting the ink jet ink composition C from the ink jet printer.

2. The method according to claim 1, wherein
the color material is a water-soluble color material.

3. The method according to claim 1, wherein
the color material is a dye.

4. The method according to claim 3, wherein
the color material is a reactive dye.

5. The method according to claim 1, wherein
the water-soluble substance being solid in an environment of 25° C. and 1 atmospheric pressure is one or more selected from a moisturizing agent, a surfactant, and a solubilizing agent.

6. The method according to claim 1, wherein
the water-soluble substance being solid in an environment of 25° C. and 1 atmospheric pressure is one or more selected from trimethylglycine, urea, and ε-caprolactam.

7. The method according to claim 1, wherein
the ink composition A has a content of a water-insoluble substance being solid in an environment of 25° C. and 1 atmospheric pressure other than the color material of 1% by mass or less with respect to the total amount of the ink composition A.

8. The method according to claim 1, wherein
a content of the color material is 35% by mass or less with respect to the total amount of the ink composition A.

9. The method according to claim 1, wherein
the ink composition A is produced by freeze-drying or spray-drying.

10. The method according to claim 1, wherein
the aqueous solution B contains water in an amount of 60% by mass or more with respect to the total amount of the aqueous solution B.

11. The method according to claim 1, wherein
the aqueous solution B further contains a water-soluble organic solvent.

12. The method according to claim 1, wherein
the ink jet printer includes at least one or more of a mechanism for mixing and stirring the ink composition A and the aqueous solution B, and a mechanism for heating the mixed ink composition A and aqueous solution B.

13. The method according to claim 1, wherein
the ink composition A is stored in a container made of a material of which a water vapor permeability in an environment of a temperature of 20° C. and a humidity of 90% RH, measured in accordance with JIS K 7129, is 5 g/m²/day or less.

14. The method according to claim 13, wherein
the container includes at least one or more of a mechanism for mixing and stirring the ink composition A and the aqueous solution B and a mechanism for heating the mixed ink composition A and aqueous solution B.

15. The method according to claim 13, wherein
a capacity of the container is 20 L or less.

16. The method according to claim 1, wherein
the ink jet printer includes an ink jet head that includes a nozzle for ejecting the ink jet ink composition C, a pressure chamber to which the ink jet ink composition C is supplied, and a circulation flow path that allows the ink jet ink composition C in the pressure chamber to be circulated.

17. An ink set comprising:
an ink composition A, which contains a color material and a water-soluble substance being solid in an environment of 25° C. and 1 atmospheric pressure, in which a content of a substance being liquid in an environment of 25° C. and 1 atmospheric pressure is 20% by mass or less with respect to a total amount of the ink composition A; and
an aqueous solution B, which contains water in an amount of 50% by mass or more with respect to a total amount of the aqueous solution B, wherein
the ink composition A and the aqueous solution B are used by being mixed such that a surface tension is 40 mN/m or less and a viscosity is 100 mPa·s or less.

18. A method of producing an ink jet ink composition, the method comprising:
mixing an ink composition A, which contains a color material and a water-soluble substance being solid in an environment of 25° C. and 1 atmospheric pressure, in which a content of a substance being liquid in an environment of 25° C. and 1 atmospheric pressure is 20% by mass or less with respect to a total amount of the ink composition A, with an aqueous solution B, which contains water in an amount of 50% by mass or more with respect to a total amount of the aqueous solution B, when used in an ink jet printer, wherein
the ink jet ink composition has a surface tension of 40 mN/m or less and a viscosity of 100 mPa·s or less.

19. An ink jet ink composition comprising:
an ink composition A, which contains a color material and a water-soluble substance being solid in an environment of 25° C. and 1 atmospheric pressure, in which a content of a substance being liquid in an environment of 25° C. and 1 atmospheric pressure is 20% by mass or less with respect to a total amount of the ink composition A; and
an aqueous solution B, which contains water in an amount of 50% by mass or more with respect to a total amount of the aqueous solution B, wherein
the ink jet ink composition has a surface tension of 40 mN/m or less and a viscosity of 100 mPa·s or less.
